(19) United States
(12) Patent Application Publication
(10) Pub. No.: US 2016/0111050 A1
(43) Pub. Date: Apr. 21, 2016

(54) DISPLAY DEVICE

(71) Applicant: Samsung Display Co., Ltd., Yongin-City (KR)

(72) Inventor: Kihyun PYUN, Gwangmyeong-si (KR)

(21) Appl. No.: 14/809,947

(22) Filed: Jul. 27, 2015

(30) Foreign Application Priority Data
Oct. 16, 2014 (KR) 10-2014-0139969

(51) Int. Cl. G09G 3/36

(52) U.S. Cl. CPC G09G 3/3607; G09G 3/3659; G09G 3/3688; G09G 2300/0452; G09G 2310/027; G09G 2320/0673; G09G 2320/0257

(57) ABSTRACT

A display device includes a first block, which has a first first-color pixel set and a first second-color pixel set, and a second block, which has a second first-color pixel set and a second second-color pixel set. A cardinality of the first first-color pixel set plus a cardinality of the first second-color pixel set is unequal to a cardinality of the second first-color pixel set plus a cardinality of the second second-color pixel set. The display device includes a data driver for generating a first data voltage and a second data voltage based on a first curve and a second curve, respectively, and for providing the first data voltage and the second data voltage to the first block and the second block, respectively. A brightness value associated with the first curve is unequal to a brightness value associated with the second curve with respect to a same grayscale level.

### CROSS-REFERENCE TO RELATED APPLICATION

This U.S. non-provisional patent application claims priority under 35 U.S.C. §119 to Korean Patent Application No. 10-2014-0139969, filed on Oct. 16, 2014; the contents of the Korean Patent Application are incorporated herein by reference.

### BACKGROUND

1. Field of the Invention

The present invention is related to a display device.

2. Description of the Related Art

Display devices have been included in various electronic devices, e.g., smart phones, digital cameras, notebook computers, and navigation systems. A display device may display colors using the three primary colors red, green, and blue. The display device may include red, green, and blue pixels for displaying the red, green, and blue colors. The display device may further include white pixels for improving brightness of images displayed by the display device.

### SUMMARY

Embodiments of the present invention may be related to a display device capable of displaying images without a significant amount of conspicuous vertical line defects.

An embodiment of the present invention may be related to a display device. The display device may include a display panel that includes a first pixel group (or first pixel block) and a second pixel group (or second pixel block). The first pixel group may include a first first-color pixel set and a first second-color pixel set. The second pixel group may include a second first-color pixel set and a second second-color pixel set. The first first-color pixel set and the second first-color pixel set may be configured to display a first color. The first second-color pixel set and the second second-color pixel set may be configured to display a second color. A sum of a number of pixels of the first first-color pixel set and a number of pixels of the first second-color pixel set may be unequal to a sum of a number of pixels of the second first-color pixel set and a number of pixels of the second second-color pixel set. In other words, the cardinality (or size) of the first first-color pixel set plus the cardinality (or size) of the first second-color pixel set may be unequal to the cardinality (or size) of the second first-color pixel set plus the cardinality (or size) of the second second-color pixel set.

The display device may further include a data driver that is configured to provide a first data voltage to the first pixel group and configured to provide a second data voltage to the second pixel group. The data driver may be configured to generate the first data voltage based on a first gamma curve. The data driver may be configured to generate the second data voltage based on a second gamma curve. A brightness value associated with (or provided by) the first gamma curve with respect to a grayscale level may be unequal to a brightness value associated with (or provided by) the second gamma curve with respect to the grayscale level. In other words, a brightness value corresponding to a grayscale level according to the first gamma curve may be unequal to a brightness value corresponding to the grayscale level according to second gamma curve.

The first pixel group further may include a first third-color pixel set. The first third-color pixel set may be configured to display a third color. A brightness coefficient of the third color may be less than a brightness coefficient of the first color. The sum of the number of pixels of the first first-color pixel set and the number of pixels of the first second-color pixel set may be less than the sum of the number of pixels of the second first-color pixel set and the number of pixels of the second second-color pixel set. The brightness value associated with the first gamma curve with respect to the grayscale level may be greater than the brightness value associated with the second gamma curve with respect to the grayscale level.

One of the first color and the second color may be white. Another one of the first color and the second color may be green.

The total number of pixels of the first pixel group may be equal to the total number of pixels of the second pixel group.

Each of the first pixel group and the second pixel group may have (or consist of) exactly three pixel columns.

A first-color pixel of the first pixel group may be positioned between a first third-color pixel of the first pixel group and a first fourth-color pixel of the first pixel group in a first direction. A second-color pixel of the first pixel group may be positioned between a second fourth-color pixel of the first pixel group and a second third-color pixel of the first pixel group in the first direction. The first third-color pixel of the first pixel group and the second third-color pixel of the first pixel group may be configured to display a third color. The first fourth-color pixel of the first pixel group and the second fourth-color pixel of the first pixel group may be configured to display a fourth color. The first-color pixel of the first pixel group may immediately neighbor the second-color pixel of the first pixel group in a second direction perpendicular to the first direction.

The first third-color pixel of the first pixel group may immediately neighbor the second fourth-color pixel of the first pixel group in the second direction. The first fourth-color pixel of the first pixel group may immediately neighbor the second third-color pixel of the first pixel group in the second direction.

The first-color pixel of the first pixel group may immediately neighbor each of the first third-color pixel of the first pixel group and the first fourth-color pixel of the first pixel group. The second-color pixel of the first pixel group may immediately neighbor each of the second fourth-color pixel of the first pixel group and the second third-color pixel of the first pixel group.

One of the third color and the fourth color may be red. Another one of the third color and the fourth color may be blue.

A third-color pixel of the second pixel group may be positioned between a first first-color pixel of the second pixel group and a first second-color pixel of the second pixel group in a first direction. A fourth-color pixel of the second pixel group may be positioned between a second second-color pixel of the second pixel group and a second first-color pixel of the second pixel group in the first direction. The third-color pixel of the second pixel group may be configured to display a third color. The fourth-color pixel of the second pixel group may be configured to display a fourth color. The third-color pixel of the second pixel group may immediately neighbor the fourth-color pixel of the second pixel group in a second direction perpendicular to the first direction.

The first first-color pixel of the second pixel group may immediately neighbor the second second-color pixel of the second pixel group in the second direction. The first second-color pixel of the second pixel group may immediately neighbor the second first-color pixel of the second pixel group in the second direction.

The third-color pixel of the second pixel group may immediately neighbor each of the first first-color pixel of the second pixel group and the first second-color pixel of the second pixel group. The fourth-color pixel of the second pixel group may immediately neighbor each of the second second-color pixel of the second pixel group and the second first-color pixel of the second pixel group.

The display panel may include a third pixel group. The second pixel group may be positioned between the first pixel group and the third pixel group. The third pixel group may include a third first-color pixel set and a third second-color pixel set. The third first-color pixel set may be configured to display the first color. The third second-color pixel set may be configured to display the second color. A sum of a number of pixels of the third first-color pixel set and a number of pixels of the third second-color pixel set may be unequal to the sum of the number of pixels of the second first-color pixel set and the number of pixels of the second second-color pixel set. The data driver may be configured to provide a third data voltage to the third pixel group. The data driver may be configured to generate the third data voltage based on the first gamma curve.

The sum of the number of pixels of the third first-color pixel set and the number of pixels of the third second-color pixel set may be equal to the sum of the number of pixels of the first first-color pixel set and the number of pixels of the first second-color pixel set.

The display panel further may include a fourth pixel group. The third pixel group may be positioned between the second pixel group and the fourth pixel group. The fourth pixel group may include a fourth first-color pixel set and a fourth second-color pixel set. The fourth first-color pixel set may be configured to display the first color. The fourth second-color pixel set may be configured to display the second color. A sum of a number of pixels of the fourth first-color pixel set and a number of pixels of the fourth second-color pixel set may be unequal to the sum of the number of pixels of the third first-color pixel set and the number of pixels of the third second-color pixel set. The data driver may be configured to provide a fourth data voltage to the fourth pixel group. The data driver may be configured to generate the fourth data voltage based on the second gamma curve.

The sum of the number of pixels of the fourth first-color pixel set and the number of pixels of the fourth second-color pixel set may be equal to the sum of the number of pixels of the second first-color pixel set and the number of pixels of the second second-color pixel set.

The data driver may include a first voltage generator configured to generate the first data voltage and may include a second voltage generator configured to generate the second data voltage, The first voltage generator may include the following elements: a first gamma voltage generator for generating a first gamma voltage according to the first gamma curve in response to a first gamma voltage control signal; and a first digital-to-analog converter for converting a first image data set to the first data voltage based on the first gamma voltage, The second voltage generator may include the following elements: a second gamma voltage generator for generating a second gamma voltage according to the second gamma curve in response to a second gamma voltage control signal; and a second digital-to-analog converter for converting a second image data set to the second data voltage based on the second gamma voltage.

The display device may include the following elements: an image mapping part for generating an intermediate data having information about the first color, the second color, a third color, and fourth color based an input image signal having information about the second color, the third color, and the fourth color; a data separating part for separating the intermediate data into the first image data set and the second image data set; and a gamma controlling part for generating the first gamma voltage control signal and the second gamma voltage control signal.

The display device may include the following elements: a first electrically conductive line that is electrically connected to each of the data separating part and the first voltage generator and is configured to transmit the first image data set from the data separating part to the first voltage generator; and a second electrically conductive line that is electrically connected to each of the data separating part and the second voltage generator and is configured to transmit the second image data set from the data separating part to the second voltage generator.

An embodiment of the invention may be related a display device including a display panel. The display panel may include pixels that are grouped into first-type blocks (or first blocks, for conciseness) and second-type blocks (or second blocks, for conciseness). Each of the blocks may include first-color pixels (or first pixels, for conciseness), second-color pixels (or second pixels, for conciseness), third-color pixels (or third pixels, for conciseness), and fourth-color pixels (or fourth pixels, for conciseness) respectively configured for displaying a first color, a second color, a third color, and a fourth color. A sum of a number of the first pixels of the first blocks and a number of the second pixels of the first blocks is smaller than a sum of a number of the first pixels of the second blocks and a number of the second pixels of the second blocks. The first blocks may receive a first data voltage generated based on a first gamma curve. The second blocks may receive a second data voltage generated based on a second gamma curve, which is different from the first gamma curve. At least one of a brightness coefficient of the first color and a brightness coefficient of the second color is greater than at least one of a brightness coefficient of the third color and a brightness coefficient of the fourth color.

A brightness value of the first gamma curve is greater than a brightness value of the second gamma curve in a same grayscale level.

The pixels are arranged in a matrix form. The number of the first pixels and the number of the second pixels of the first blocks and second blocks in each row satisfy the relation of “q+p<r+s”. The “q” denotes the number of the first pixels of the first blocks in each row, the “p” denotes the number of the second pixels of the first blocks in each row, the “r” denotes the number of the first pixels of the second blocks in each row, and the “s” denotes the number of the second pixels of the second blocks in each row.

The first blocks and the second blocks are alternately arranged in a row direction.

The total number of pixels included in the first blocks is equal to the total number of pixels included in the second blocks.

The pixels of each block of the first blocks and second blocks are arranged in a matrix form of i rows by j columns.

The j is 3.

The display device further includes a data driver. The data driver may include a first voltage generator configured to generate the first data voltage and may include a second voltage generator configured to generate the second data voltage.

The first voltage generator includes a first gamma voltage generator for generating a first gamma voltage according to the first gamma curve in response to a first gamma voltage control signal and includes a first digital-to-analog converter for converting a first image data set to the first data voltage based on the first gamma voltage. The second voltage generator includes a second gamma voltage generator for generating a second gamma voltage according to the second gamma curve in response to a second gamma voltage control signal and includes a second digital-to-analog converter for converting a second image data to the second data voltage based on the second gamma voltage.

The display device further includes a timing controller. The timing controller includes the following elements: an image mapping part for generating an intermediate data having information about four colors based on an input image signal having information about three colors, a data separating part for separating the intermediate data into the first image data set and the second image data set, and a gamma controlling part for generating the first gamma voltage control signal and the second gamma voltage control signal.

The display device further includes a first line that is connected to the data separating part and the first voltage generator and is configured to transmit the first image data set to the first voltage generator. The display device further includes a second line that is connected to the data separating part and the second voltage generator and is configured to transmit the second image data set to the second voltage generator.

The first color, the second color, the third color, and the fourth color are white, green, red, and blue, respectively.

Pixels are repeatedly arranged according to a pattern of a fourth pixel, a first pixel immediately neighboring the fourth pixel, a third pixel immediately neighboring the first pixel, and a second pixel immediately neighboring the third pixel in each even-numbered row of the display panel. Pixels are repeatedly arranged according to a pattern of a third pixel, a second pixel immediately neighboring the third pixel, a fourth pixel immediately neighboring the second pixel, and a first pixel immediately neighboring the fourth pixel in each odd-numbered row of the display panel.

The display panel is a liquid crystal display panel.

According to embodiments of the invention, a first data voltage generated based on a relatively brighter first gamma curve is applied to first blocks, which include relative fewer bright-color pixels, and a second data voltage generated based on a relatively darker second gamma curve is applied to second blocks, which relatively more bright-color pixels. Thus, brightness differences between the first blocks and the second blocks may be minimized. As a result, conspicuous vertical line defects may be substantially prevented from occurring in displayed images. Advantageously, satisfactory image quality may be attained.

### BRIEF DESCRIPTION OF THE DRAWINGS

FIG. 1 is a block diagram illustrating elements and/or structures of a display device according to an embodiment of the present invention.

FIG. 2 is an equivalent circuit diagram illustrating elements and/or structures of a pixel shown in FIG. 1 according to an embodiment of the present invention.

FIG. 3 is a block diagram illustrating elements and/or structures of a timing controller shown in FIG. 1 according to an embodiment of the present invention.

FIG. 4 is a block diagram illustrating elements and/or structures of a data driver shown in FIG. 1 according to an embodiment of the present invention.

FIG. 5 is a block diagram illustrating elements and/or structures of a first gamma voltage generator and a first digital-to-analog converter shown in FIG. 4 according to an embodiment of the present invention.

FIG. 6 is a block diagram illustrating elements and/or structures of a second gamma voltage generator and a second digital-to-analog converter shown in FIG. 4 according to an embodiment of the present invention.

FIG. 7 is a schematic plan view illustrating elements and/or structures of a display panel shown in FIG. 1 according to an embodiment of the present invention.

### DETAILED DESCRIPTION

In this application, although the terms “first”, “second”, etc. may be used herein to describe various elements, these elements, should not be limited by these terms. These terms may be used to distinguish one element from another element. Thus, a first element discussed below may be termed a second element without departing from the teachings of the present invention. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

In this application, if a first element is referred to as being “on”, “connected to”, or “coupled to” a second element, the first element can be directly on, connected, or coupled to the second element, or an intervening element may be present between the first element and the second element. If a first element is referred to as being “directly on”, “directly connected to”, or “directly coupled to” a second element, there may be no intended intervening elements (except environmental elements such as air) involved in the “on” relation, the connection, or the coupling. Like numbers may refer to like elements. The term “and/or” may include any and all combinations of one or more of the associated items.

The term “connect” may mean “electrically connect”. The term “insulate” may mean “electrically insulate”.

Spatially relative terms, such as “beneath”, “below”, “lower”, “above”, “upper” and the like, may be used herein for ease of description to describe one element's relationship to another element illustrated in the figures. That the spatially relative terms may encompass different orientations of the device in use or operation in addition to the orientation depicted in the figures. For example, if the device in the figures is turned over, elements described as “below” or “beneath” other elements would then be positioned “above” the other elements. Thus, term “below” can encompass both a position of above and below. The device may be otherwise oriented (e.g., rotated 90 degrees or at other orientations), and the spatially relative descriptors may be interpreted accordingly.

The terminology used herein is for the purpose of describing particular embodiments and is not intended to be limiting of the invention. As used herein, the singular forms, “a”, “an”, and “the” are intended to include the plural forms as well, unless the context clearly indicates otherwise. The terms “includes” and/or “including”, when used in this specification, may specify the presence of stated steps and/or elements and may not preclude the presence or addition of one or more other steps and/or elements.

Unless otherwise defined, all terms (including technical and scientific terms) used herein have the same meaning as commonly understood by one of ordinary skill in the art to which this invention belongs. Terms, such as those defined in commonly used dictionaries, should be interpreted as having a meaning that is consistent with their meaning in the context of the relevant art and should not be interpreted in an idealized or overly formal sense unless expressly so defined herein.

Various embodiments, including methods and techniques, are described in this disclosure. Embodiments of the invention may also cover an article of manufacture that includes a non-transitory computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover devices for practicing embodiments of the invention. Such device may include circuits, dedicated and/or programmable, to carry out operations pertaining to embodiments of the invention. Examples of such device include a general purpose computer and/or a dedicated computing device when appropriately programmed and may include a combination of a computer/computing device and dedicated/programmable hardware circuits (such as electrical, mechanical, and/or optical circuits) configured for the various operations pertaining to embodiments of the invention.

In the following description, a liquid crystal display may be described as an example of a display device. In embodiments of the invention, the display device should not be limited to a liquid crystal display. For instance, the display device may be a plasma display device, an electrophoretic display device, or an electrowetting display device.

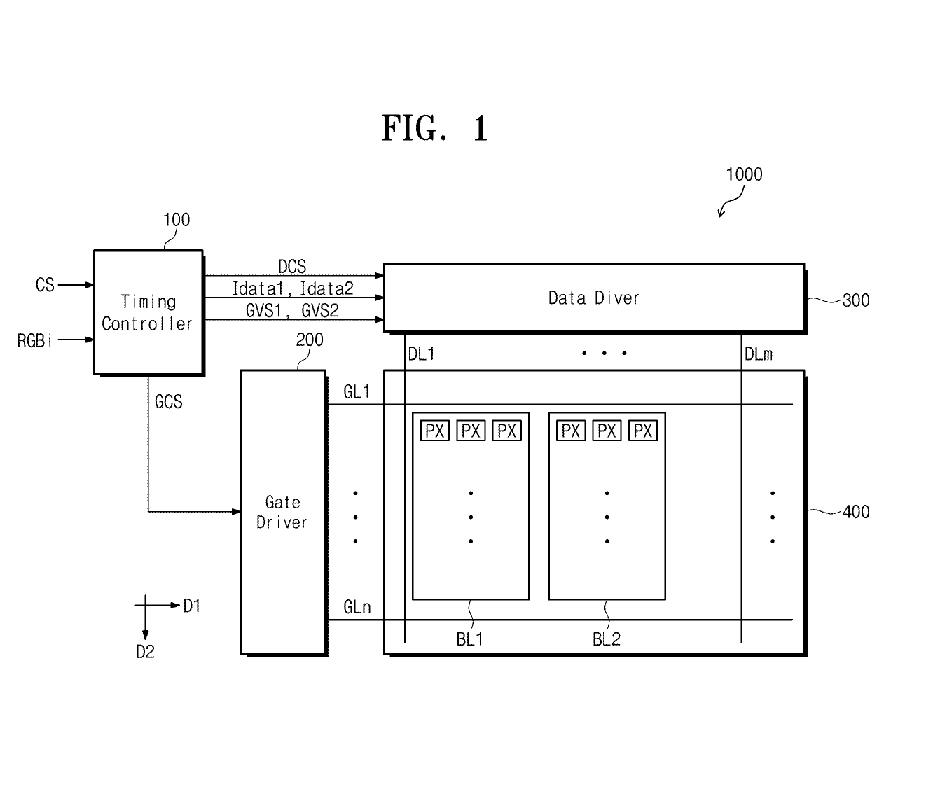

FIG. 1 is a block diagram illustrating elements and/or structures of a display device 1000 according to an embodiment of the present invention.

Referring to FIG. 1, the display device 1000 includes a display panel 400 configured for displaying images, a gate driver 200 and a data driver 300 configured for controlling the display panel 400, and a timing controller 100 configured for controlling the gate driver 200 and the data driver 300.

The timing controller 100 may receive an input image signal RGBi and a plurality of control signals CS from a device external to the display device 1000. The timing controller 100 may convert a data format of the input image signal RGBi to a data format appropriate to an interface between the data driver 300 and the timing controller 100, may generate output image data, and may provide the output image data to the data driver 300. As an example, the output image data may include first image data Idata1 and second image data Idata2.

The timing controller 100 may generate a data control signal DCS (which may include an output start signal and a horizontal start signal) and a gate control signal GCS (which may include a vertical start signal, a vertical clock signal, and a vertical clock bar signal) based on the control signals CS. The data control signal DCS may be applied to the data driver 300, and the gate control signal GCS may be applied to the gate driver 200.

The gate driver 200 may sequentially output gate signals in response to the gate control signal GCS (provided from the timing controller 100).

The data driver 300 may convert the output image data Idata1 and Idata2 to data voltages in response to the data control signal DCS (provided from the timing controller 100) and may apply the data voltages to the display panel 400. In detail, the data driver 300 converts the first image data Idata1 and the second image data Idata2 to first-type data voltages (or first data voltages, for conciseness) and second-type data voltages (or second data voltages, for conciseness), respectively, and may apply the first data voltages and the second data voltages to the display panel 400.

The display panel 400 includes a plurality of gate lines GL1 to GLn, a plurality of data lines DL1 to DLm, and a plurality of pixels PX.

Each pixel PX may be used as a minimum unit to display an image. A resolution of the display panel 400 may depend on the number of pixels PX. Most or all of the pixels PX may have analogous or identical structures and/or functions, and a pixel PX may be described as an example.

Each pixel PX may be configured to display one of several primary colors. The primary colors may include red, green, blue, and white. Alternatively or additionally, the primary colors may include one or more other colors, such as one or more of yellow, cyan, magenta, etc.

The gate lines GL1 to GLn extend in a first direction D1 and are arranged substantially parallel to each other in a second direction D2 substantially perpendicular to the first direction D1. The gate lines GL1 to GLn are connected to the gate driver 200 and may sequentially receive the gate signals from the gate driver 200. The gate signals may be sequentially applied to the gate lines GL1 to GLn according to the second direction D2.

The data lines DL1 to DLm extend in the second direction D2 and are arranged substantially parallel to each other in the first direction D1. The data lines DL1 to DLm are connected to the data driver 300 and may receive the data voltages (including the first data voltages and the second data voltages) from the data driver 300.

Each pixel PX is connected to a corresponding gate line of the gate lines GL1 to GLn and a corresponding data line of the data lines DL1 to DLm. Each pixel PX may be turned on or turned off in response to the gate signal applied to the pixel PX. A turned-on pixel PX may display an image portion corresponding to the data voltage applied to the turned-on pixel PX.

A polarity of the data voltage applied to each pixel PX may be inverted every frame period to prevent liquid crystals included in the display panel 400 from burning or deteriorating. The data driver 300 may invert the polarities of the data voltages every frame period in response to an inversion signal (included in the data control signal DCS) and may output the inverted data voltages. In an embodiment, when an image corresponding to one frame period is displayed, the polarities of the data voltages may be inverted in a unit of two data lines, to improve display quality of the pixels PX.

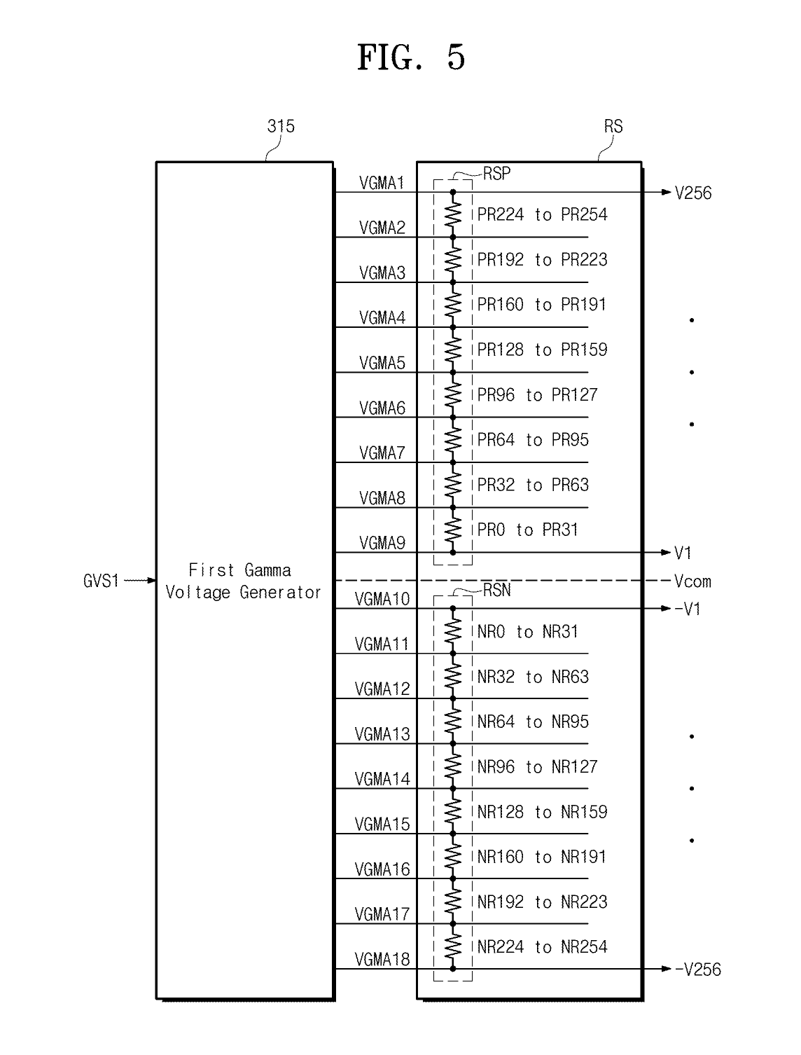

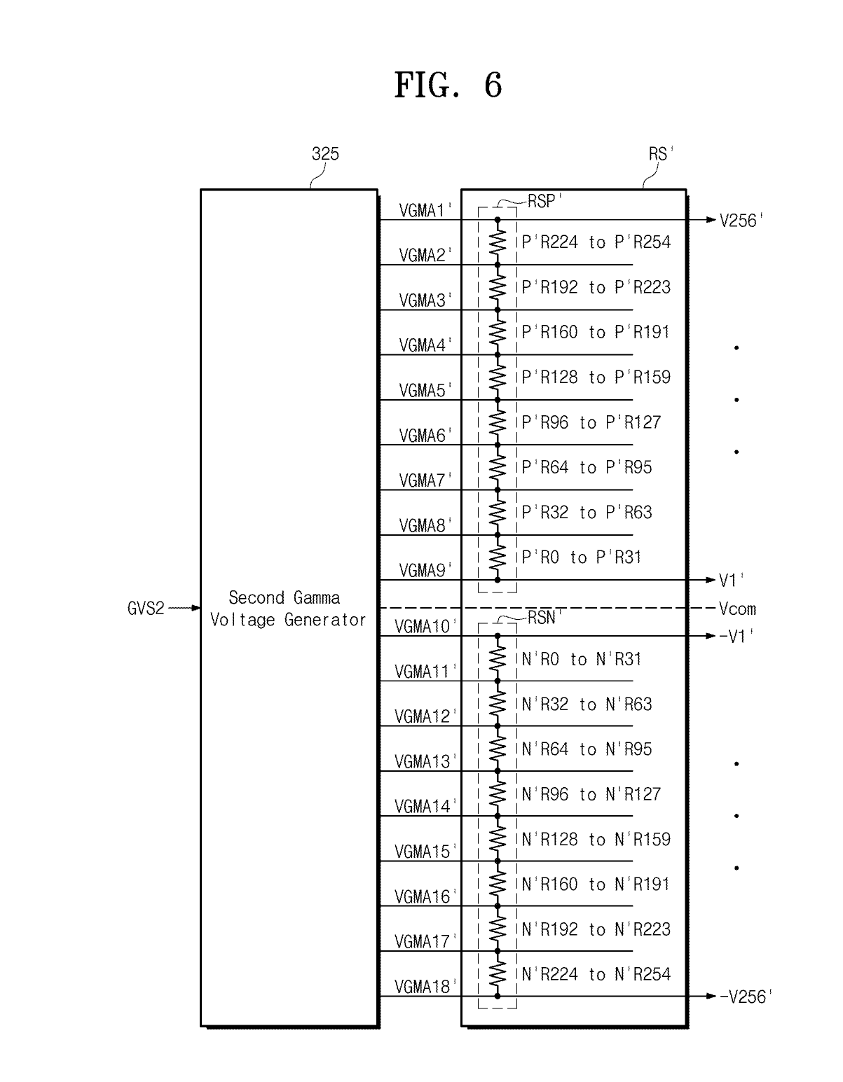

The display panel 400 may include first-type pixel blocks BL1 (or first blocks BL1, for conciseness) and second-type pixel blocks BL2 (or second blocks BL2, for conciseness). Each pixel block may include a plurality of pixels PX. The first blocks BL1 and the second blocks BL2 are alternately arranged along the first direction D1. FIG. 1 shows one first block BL1 and one second block BL2 as a representative example. The pixels PX of the first blocks BL1 may receive the first data voltages, and the pixels PX of the second blocks BL2 may receive the second data voltages. The blocks BL1 and BL2 are further described with reference to FIG. 5 and FIG. 6.

The timing controller 100 may provide a first gamma voltage control signal GVS1 and a second gamma voltage control signal GVS2 to the data driver 300. The data driver 300 may convert the first image data Idata1 to the first data voltages in response to gamma voltages generated based on the first gamma voltage control signals GVS1. The data driver 300 may convert the second image data Idata2 to the second data voltages in response to gamma voltages generated based on the second gamma voltage control signal GVS2.

The timing controller 100 may be mounted on a printed circuit board (e.g., in the form of an integrated circuit chip) and may be connected to the gate driver 200 and the data driver 300.

In an embodiment, each of the gate driver 200 and the data driver 300 may include a plurality of driving chips, may be mounted on a flexible printed circuit board, and may be connected to the display panel 400 in a tape carrier package (TCP) configuration.

In an embodiment, each of the gate driver 200 and the data driver 300 may include a plurality of driving chips and may be mounted on the display panel 400 in a chip-on-glass (COG) configuration.

In an embodiment, the gate driver 200 may be substantially simultaneously formed together with transistors of the pixels PX and may be mounted on the display panel 400 in an amorphous silicon TFT gate driver circuit (ASG) configuration.

The display panel 400 may include two substrates facing each other and may include a liquid crystal layer interposed between the two substrates. The display device 1000 may include a backlight unit disposed at a rear side of the display panel 400 to provide a light to the display panel 400.

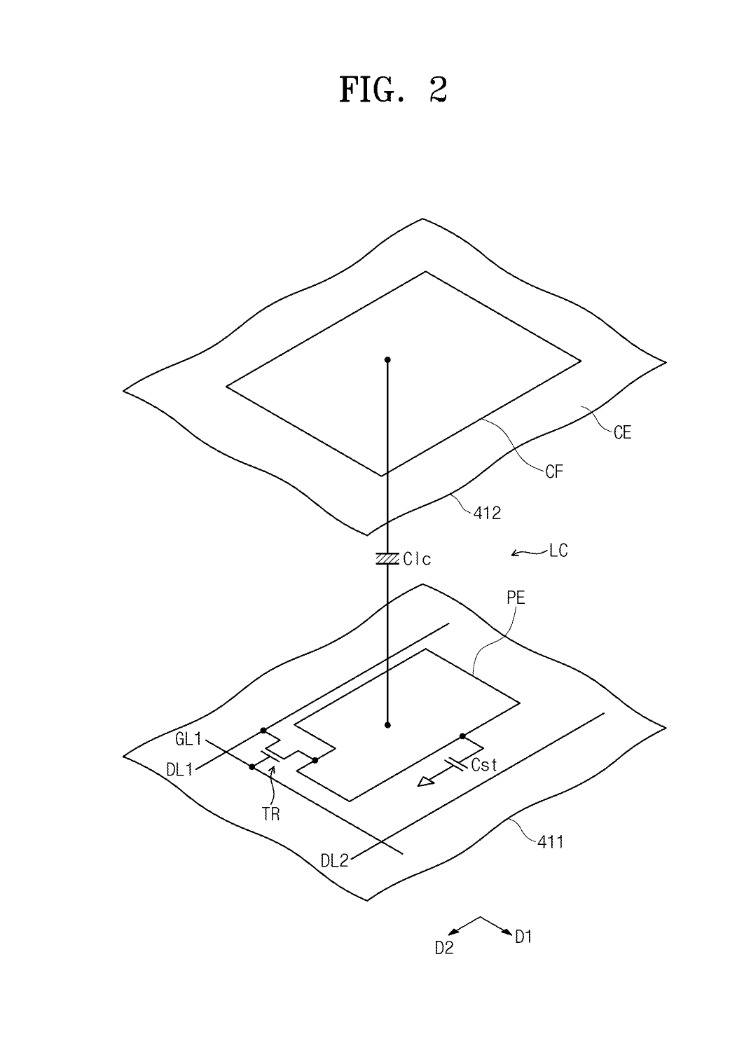

FIG. 2 is an equivalent circuit diagram illustrating elements and/or structures of a pixel PX shown in FIG. 1 according to an embodiment of the present invention. The pixel PX may be connected to a gate line GL1 and a data line DL1.

Referring to FIG. 2, the display panel 400 includes a substrate 411, a substrate 412 facing the substrate 411, and a liquid crystal layer LC interposed between the substrate 411 and the substrate 412.

The pixel PX includes a transistor TR connected to the gate line GL1 and the data line DL1, a liquid crystal capacitor Clc connected to the transistor TR, and a storage capacitor Cst connected in parallel to the liquid crystal capacitor Clc. The storage capacitor Cst may be omitted.

The transistor TR may be disposed on the substrate 411. The transistor TR includes a gate electrode connected to the gate line GL1, a source electrode connected to the data line DL1, and a drain electrode connected to the liquid crystal capacitor Clc and the storage capacitor Cst.

The liquid crystal capacitor Clc may be formed by a pixel electrode PE disposed on the substrate 411, a common electrode CE disposed on the substrate 412, and the liquid crystal layer LC interposed between the pixel electrode PE and the common electrode CE. The liquid crystal layer LC may serve as a dielectric member of the liquid crystal capacitor Clc. The pixel electrode PE is connected to the drain electrode of the transistor TR.

The common electrode CE may be disposed on the substrate 412 or on the substrate 411. In an embodiment, at least one of the pixel electrode PE and the common electrode CE may include a slit structure.

The storage capacitor Cst may be formed by the pixel electrode PE, a storage electrode (not shown) branched from a storage line (not shown), and an insulating layer interposed between the pixel electrode PE and the storage electrode. The storage line may be disposed on the substrate 411 and may be substantially simultaneously formed together with the gate lines GL1 to GLn on the same layer. The storage electrode may partially overlap the pixel electrode PE.

The pixel PX may further include a color filter CF for displaying one of the primary colors. The color filters CF may be disposed on the substrate 412 or on the substrate 411.

The transistor TR may be turned on in response to the gate signal provided through the gate line GL1. The data voltage provided through the data line DL1 may be applied to the pixel electrode PE of the liquid crystal capacitor Clc through the turned-on transistor TR. The common electrode CE may receive a common voltage.

An electric field may be formed between the pixel electrode PE and the common electrode CE due to a difference between the data voltage and the common voltage. Liquid crystal molecules of the liquid crystal layer LC may be controlled by the electric field generated between the pixel electrode PE and the common electrode CE, such that a light transmittance of the pixel PX may be controlled, and thus a desired image portion may be displayed by the pixel PX.

The storage line may receive a storage voltage having a uniform voltage level or may receive the common voltage. The storage capacitor Cst may maintain the level of the voltage charged in the liquid crystal capacitor Clc.

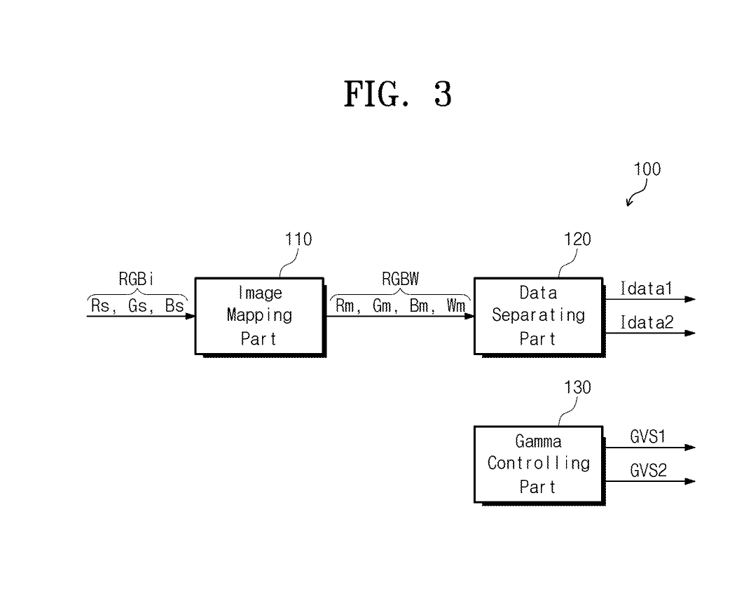

FIG. 3 is a block diagram illustrating elements and/or structures of the timing controller 100 shown in FIG. 1 according to an embodiment of the present invention.

Referring to FIG. 3, the timing controller 100 may include an image mapping part 110, a data separating part 120, and a gamma controlling part 130.

The image mapping part 110 may receive the input image signal RGBi. The image mapping part 110 may generate intermediate data RGBW having information about four colors based on the input image signal RGBi. In an embodiment, the image mapping part 110 may map an RGB color gamut of the input image signal RGBi to an RGBW color gamut through a gamut mapping algorism (GMA) to generate the intermediate data RGBW.

The input image signal RGBi may include red signals Rs, green signals Gs, and blue signals Bs respectively having information related to red, green, and blue. The intermediate data RGBW may include red intermediate data Rm, green intermediate data Gm, blue intermediate data Bm, and white intermediate data Wm respectively having information related to red, green, blue, and white.

The image mapping part 110 may generates the intermediate data Rm, Gm, Bm, and Wm using the signals Rs, Gs, and Bs. As an example, the image mapping part 110 may set a minimum value of grayscale values of the signals Rs, Gs, and Bs corresponding to one pixel as a grayscale value of the white intermediate data Wm. In an embodiment, the grayscale values of the intermediate data Rm, Gm, and Bm may be obtained by subtracting the grayscale value of the white intermediate data Wm from the grayscale values of the signals Rs, Gs, and Bs.

The data separating part 120 may receive the intermediate data RGBW. The data separating part 120 may separate the intermediate data RGBW to generate the first image data Idata1 and the second image data Idata2. The first image data Idata1 may correspond to the pixels included in the first blocks BL1 (illustrated in FIG. 1), and the second image data Idata2 correspond to the pixels included in the second blocks BL2 (illustrated in FIG. 1).

The gamma controlling part 130 may generate the first gamma voltage control signal GVS1 and the second gamma voltage control signal GVS2. The gamma voltage control signals GVS1 and GVS2 may be predetermined to prevent conspicuous vertical line defects from occurring/appearing in the first blocks BL1 and the second blocks BL2

In the timing controller 100, the gamma controlling part 130 and the data separating part 120 may be implemented as two functional units or may be implemented as a combined functional unit. The first gamma voltage control signal GVS1 and the second gamma voltage control signal GVS2 may be correspond to the first image data Idata1 and the second image data Idata2, respectively.

In an embodiment, the timing controller 100 and/or the image mapping part 110 may further include an input gamma converter at a front stage of the timing controller 100 and/or the image mapping part 110. The input gamma converter may adjust a gamma characteristic of the input image signal RGBi and may output the adjusted input image signal RGBi in order to facilitate the following data processing scheme. In an embodiment, the input gamma converter may linearize the input image signal RGBi to allow a non-linear gamma characteristic of the input image signal RGBi to be in proportion to brightness.

In an embodiment, the timing controller 100 and/or the data separating part 120 may include an output gamma converter at a rear stage of the timing controller 100 and/or the data separating part 120. The output gamma converter may perform an inverse gamma correction process on the image data Idata1 and Idata2 to non-linearize the first image data Idata1 and the second image data Idata2 and may output the non-linearized image data Idata1 and Idata2.

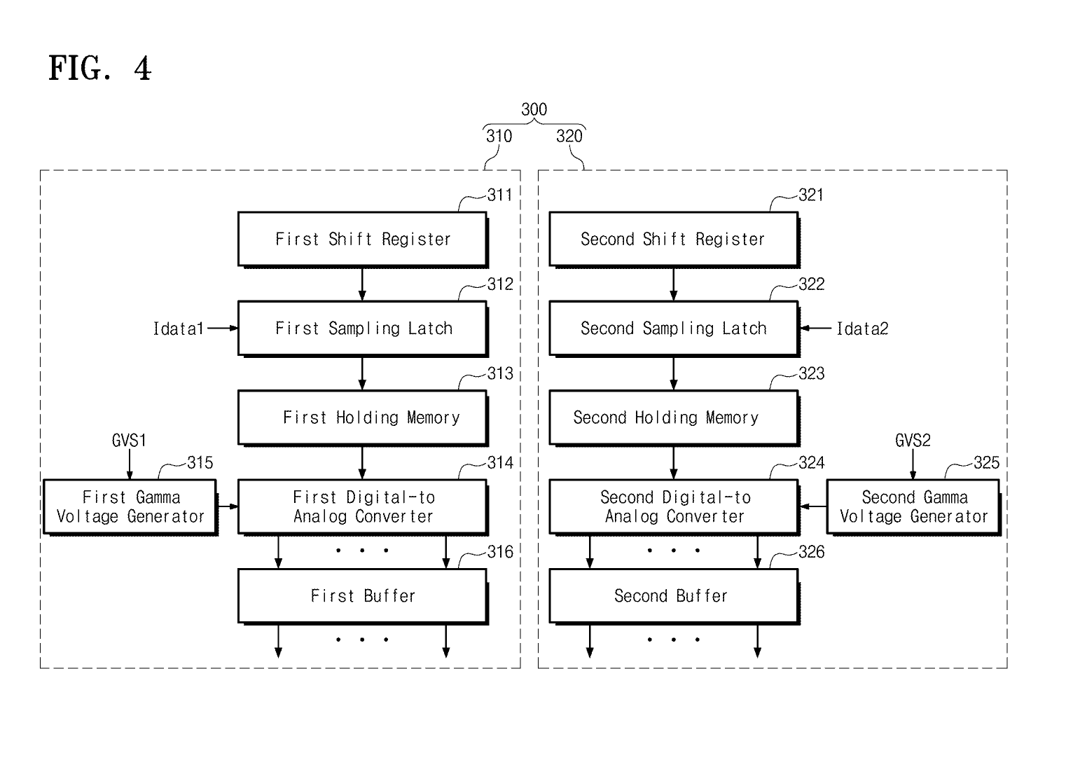

FIG. 4 is a block diagram illustrating elements and/or structures of the data driver 300 shown in FIG. 1 according to an embodiment of the present invention.

Referring to FIG. 4, the data driver 300 includes a first voltage generator 310 for generating the first data voltages and includes a second voltage generator 320 for generating the second data voltages.

The first voltage generator 310 includes a first shift register 311, a first sampling latch 312, a first holding memory 313, a first digital-to-analog converter 314, a first gamma voltage generator 315, and a first buffer 316.

The first shift register 311 includes a plurality of sequentially connected stages (not shown). A clock signal may be applied to each stage of the stages, and the horizontal start signal may be applied to a first stage of the stages. When the first stage starts an operation in response to the horizontal start signal, the stages may sequentially output sampling signals in response to the clock signal.

The first sampling latch 312 may receive the first image data Idata1 and may sequentially sample data sets (among the first image data Idata1) that respectively correspond to horizontal lines in response to the sampling signals sequentially received from the stages. The first sampling latch 312 may output a data set corresponding to each horizontal line to the first holding memory 313 in response to a latch signal.

The first image data Idata1 may be provided to the first voltage generator 310 from the data separating part 120 through a first line (illustrated in FIG. 3), which electrically connects the data separating part 120 and the first voltage generator 310.

The first holding memory 313 may hold a data set corresponding to one horizontal line (and received from the first sampling latch 312) during/for one horizontal period and may provide the data set corresponding to the horizontal line to the first digital-to-analog converter 314 during or at the end of the one horizontal period.

The first gamma voltage generator 315 may generate a first gamma voltage set (or first gamma voltage, for conciseness) corresponding to a first gamma curve in response to the first gamma voltage control signal GVS1. The first gamma curve may be determined based on the first gamma voltage control signal GVS1.

The first digital-to-analog converter 314 may convert data sets corresponding to horizontal lines to first-type data voltages (or first data voltages, for conciseness) based on the first gamma voltage. The first digital-to-analog converter 314 may output the first data voltages to the first buffer 316.

The first buffer 316 may receive first data voltages from the first digital-to-analog converter 314 and may output the first data voltages to the first blocks BL1 in response to a load signal. Each first block BL1 may receive some first data voltages.

FIG. 5 is a block diagram illustrating elements and/or structures of the first gamma voltage generator 315 and the first digital-to-analog converter 314 shown in FIG. 4 according to an embodiment of the present invention.

Referring to FIG. 5, the first gamma voltage includes eighteen gamma reference voltages VGMA1, VGMA2, VGMA3, VGMA4, VGMA5, VGMA6, VGMA7, VGMA8, VGMA9, VGMA10, VGMA11, VGMA12, VGMA13, VGMA14, VGMA15, VGMA16, VGMA17, and VGMA18. The gamma reference voltages VGMA1 to VGMA18 may have voltage levels that are determined according to the first gamma curve.

The first digital-to-analog converter 314 includes a resistance string set RS configured to convert the eighteen gamma reference voltages VGMA1 to VGMA18 to “2×2^{k}” grayscale voltages (wherein “k” is a natural number equal to or greater than 1). In an embodiment, “k” may be equal to the number of bits of a data set. In an embodiment, the data set is 8-bit, and the resistance string RS may convert the eighteen gamma reference voltages VGMA1 to VGMA18 to 512 grayscale voltages.

The resistance string set RS includes a positive resistance string RSP and a negative resistance string RSN in order to give polarity to the grayscale voltages. The positive resistance string RSP may include resistors R0P to R31P, R32P to R63P, R64P to R95P, R96P to R127P, R128P to R159P, R160P to R191P, R192P to R223P, and R224P and R254P. The positive resistance string RSP may generate 256 first-type positive-polarity grayscale voltages (or first positive-polarity grayscale voltages, for conciseness) V1 to V256 based on the first to ninth gamma reference voltages VGMA1 to VGMA9 of the gamma reference voltages VGMA1 to VGMA18. The negative resistance string RSN may include resistors R0N to R31N, R32N to R63N, R64N to R95N, R96N to R127N, R128N to R159N, R160N to R191N, R192N to R223N, and R224N to R254N. The negative resistance string RSN may generate 256 first-type negative-polarity grayscale voltages (or first negative-polarity grayscale voltages, for conciseness) −V1 to −V256 based on the tenth to eighteenth gamma reference voltages VGMA10 to VGMA18 of the gamma reference voltages VGMA1 to VGMA18. In an embodiment, a voltage level of a VGMAm is greater than a voltage level of a VGMAn for the gamma reference voltages VGMA1 to VGMA18, wherein m is less than n, wherein m is an integer in a range of 1 to 17, and wherein n is an integer in a range of 2 to 18.

Each of the first positive-polarity grayscale voltages V1 to V256 may have a positive value with respect to a predetermined reference voltage (hereinafter, referred to as the common voltage Vcom), and each of the first negative-polarity grayscale voltages −V1 to −V256 may have a negative value with respect to the common voltage Vcom. In an embodiment, a first positive-polarity grayscale voltage (among the first positive-polarity grayscale voltages V1 to V256) may have a higher grayscale value (i.e., a value closer to the white grayscale) if the voltage difference between the voltage level of the first positive-polarity grayscale voltage and the voltage level of the common voltage Vcom is larger; a first positive-polarity grayscale voltage may have a lower grayscale value (i.e., a value closer to the black grayscale) if the voltage difference between the voltage level of the first positive-polarity grayscale voltage and the voltage level of the common voltage Vcom is smaller. A first negative-polarity grayscale voltage (among the first negative-polarity grayscale voltages −V1 to −V256) may have a higher grayscale value (closer to the white grayscale) if the voltage difference between the voltage level of the first negative-polarity grayscale voltage and the voltage level of the common voltage Vcom is larger; a first negative-polarity grayscale voltage may have a lower grayscale value (closer to the black grayscale) if the voltage difference between the voltage level of the first negative-polarity grayscale voltage and the voltage level of the common voltage Vcom is smaller.

Referring to FIG. 4 and FIG. 5, the first digital-to-analog converter 314 may select one of the positive resistance string RSP and the negative resistance string RSN based on the inversion signal, may select (according to the selected resistance string PSP or RSN) a positive-polarity grayscale voltage or a negative-polarity grayscale voltage corresponding to a data set received from the first holding memory 313, and may output the selected grayscale voltage as a first data voltage (or first-type data voltage).

Referring to FIG. 4, the second voltage generator 320 includes a second shift register 321, a second sampling latch 322, a second holding memory 323, a second digital-to-analog converter 324, a second gamma voltage generator 325, and a second buffer 326.

The structures and functions of the second shift register 321, the second sampling latch 322, the second holding memory 323, and the second buffer 326 may be substantially similar to those of the first shift resister 321, the first sampling latch 312, the first holding memory 313, and the first buffer 316.

The second shift register 321 includes a plurality of sequentially connected stages (not shown). A clock signal may be applied to each stage of the stages, and the horizontal start signal may be applied to a first stage of the stages. When the first stage starts an operation in response to the horizontal start signal, the stages may sequentially output sampling signals in response to the clock signal.

The second sampling latch 322 receives the second image data Idata2 and may sequentially sample data sets (among the first image data Idata2) that respectively correspond to horizontal lines in response to the sampling signals sequentially received from the stages. The second sampling latch 322 may output a data set corresponding to each horizontal line to the second holding memory 323 in response to a latch signal.

The second image data Idata2 may be provided to the second voltage generator 320 from the data separating part 120 through a second line (illustrated in FIG. 3), which electrically connects the data separating part 120 and the second voltage generator 320.

The second holding memory 323 may hold a data corresponding to one horizontal line (and received from the second sampling latch 322) during/or one horizontal period and may provide the data set corresponding to the horizontal line to the second digital-to-analog converter 324 during or at the end of the one horizontal period.

The second gamma voltage generator 325 may generate a second gamma voltage set (or second gamma voltage, for conciseness) corresponding to a second gamma curve in response to the second gamma voltage control signal GVS2. The second gamma curve may be determined based on the second gamma voltage control signal GVS2.

The second digital-to-analog converter 324 may convert data sets corresponding to horizontal lines to second-type data voltages (or second data voltages, for conciseness) based on the second gamma voltage. The second digital-to-analog converter 324 may output the second data voltages to the second buffer 326.

The second buffer 326 may receive second data voltages from the second digital-to-analog converter 324 and may output the second data voltages to the second blocks BL2 in response to a load signal. Each second block BL2 may receive some second data voltages.

FIG. 6 is a block diagram illustrating elements and/or structures of the second gamma voltage generator 325 and the second digital-to-analog converter 324 shown in FIG. 4 according to an embodiment of the present invention.

Referring to FIG. 6, the second gamma voltage includes eighteen gamma reference voltages VGMA1′, VGMA2′, VGMA3′, VGMA4′, VGMA5′, VGMA6′, VGMA7′, VGMA8′, VGMA9′, VGMA10′, VGMA11′, VGMA12′, VGMA13′, VGMA14′, VGMA15′, VGMA16′, VGMA17′, and VGMA18′. The gamma reference voltages VGMA1′ to VGMA18′ may have voltage levels that are determined according to the second gamma curve.

The second digital-to-analog converter 324 includes a resistance string set RS′ configured to convert the eighteen gamma reference voltages VGMA1′ to VGMA18′ to “2×2^{k}” grayscale voltages (wherein “k” is a natural number equal to or greater than 1). In an embodiment, “k” may equal to the number of bits of a data set. In an embodiment, when the data is 8-bit, and the resistance string RS may convert the eighteen gamma reference voltages VGMA1′ to VGMA18′ to 512 grayscale voltages.

The resistance string set RS includes a positive resistance string RSP′ and a negative resistance string RSN′ in order to give polarity to the grayscale voltages. The positive resistance string RSP′ may include resistors R0P′ to R31P′, R32P′ to R63P′, R64P′ to R95P′, R96P′ to R127P′, R128P′ to R159P′, R160P′ to R191P′, R192P′ to R223P′, and R224P′ and R254P′. The positive resistance string RSP may generate 256 second-type positive-polarity grayscale voltages (or second positive-polarity grayscale voltages, for conciseness) V1′ to V256′ based on the first to ninth gamma reference voltages VGMA1′ to VGMA9′ of the gamma reference voltages VGMA1′ to VGMA18′. The negative resistance string RSN′ may include resistors R0N′ to R31N′, R32N′ to R63N′, R64N′ to R95N′, R96N′ to R127N′, R128N′ to R159N′, R160N′ to R191N′, R192N′ to R223N′, and R224N′ to R254N′. The negative resistance string RSN generates 256 second-type negative-polarity grayscale voltages −V1′ to −V256′ (or first negative-polarity grayscale voltages, for conciseness) based on the tenth to eighteenth gamma reference voltages VGMA10′ to VGMA18′ of the gamma reference voltages VGMA1′ to VGMA18′. In an embodiment, a voltage level of a VGMAa′ is greater than a voltage level of a VGMAb′ for the gamma reference voltages VGMA1′ to VGMA18′, wherein a is less than b, wherein a is an integer in a range of 1 to 17, and wherein b is an integer in a range of 2 to 18.

Each of the second positive-polarity grayscale voltages V1′ to V256′ may have a positive value with respect to the common voltage Vcom, and each of the second negative-polarity grayscale voltages −V1′ to −V256′ may have a negative value with respect to the common voltage Vcom. In an embodiment, a second positive-polarity grayscale voltage (among the second positive-polarity grayscale voltages V1′ to V256′) may have a higher grayscale value (i.e., a value closer to a white grayscale) if the voltage difference between the voltage level of the second positive-polarity grayscale voltage and the voltage level of the common voltage Vcom is larger; a second positive-polarity grayscale voltage may have a lower grayscale value (i.e., a value closer to the black grayscale) if the voltage difference between the voltage level of the second positive-polarity grayscale voltage and the voltage level of the common voltage Vcom is smaller. A second negative-polarity grayscale voltage (among the second negative-polarity grayscale voltages −V1′ to −V256′) may have a higher grayscale value (closer to the white grayscale) if the voltage difference between the voltage level of the second negative-polarity grayscale voltage and the common voltage Vcom is larger; a second negative-polarity grayscale voltage may have a lower grayscale value (closer to the black grayscale) if the voltage difference between the voltage level of the second negative-polarity grayscale voltage and the voltage level of the common voltage Vcom is smaller.

Referring to FIG. 4 and FIG. 6, the second digital-to-analog converter 324 may select one of the positive resistance string RSP′ and the negative resistance string RSN′ based on the inversion signal, may select (according to the selected resistance string PSP′ or RSN′) a positive-polarity grayscale voltage or a negative-polarity grayscale voltage corresponding to a data set received from the second holding memory 323, and may output the selected grayscale voltage as a second data voltage (or second-type data voltage).

The second gamma curve is different from the first gamma curve. In an embodiment, the first gamma curve has a brightness value different from that of the second gamma curve with respect to the same grayscale level. In an embodiment, the brightness value of the first gamma curve is greater than the brightness value of the second gamma curve with respect to the same grayscale level.

As described above, the first positive-polarity grayscale voltages V1 to V256 and the first negative-polarity grayscale voltages −V1 to −V256 are generated using the gamma reference voltages VGMA1 to VGMA18 generated based on the first gamma curve. The second positive-polarity grayscale voltages V1′ to V256′ and the second negative-polarity grayscale voltages −V1′ to −V256′ are generated using the gamma reference voltages VGMA1′ to VGMA18′ generated based on the second gamma curve. Therefore, a first data voltage is generated based on the first gamma curve, and a second data voltage is generated based on the second gamma curve.

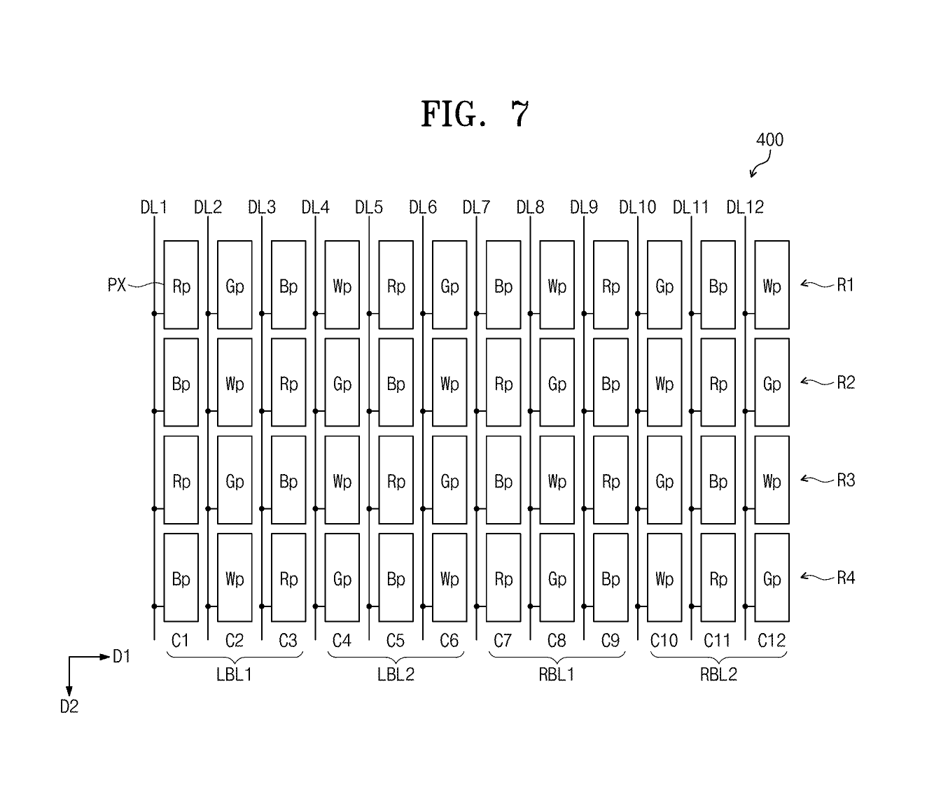

FIG. 7 is a schematic plan view illustrating elements and/or structures of the display panel 400 shown in FIG. 1 according to an embodiment of the present invention.

Some pixels PX connected to the data lines DL1 to DL12 are shown in FIG. 7. Red pixels, green pixels, blue pixels, and white pixels are respectively indicated by Rp, Gp, Bp, and Wp in FIG. 7.

Referring to FIG. 7, the pixels PX may include a plurality of red pixels Rp configured for displaying a red color, a plurality of green pixels Gp configured for displaying a green color, a plurality of blue pixels Bp configured for displaying a blue color Bp, and a plurality of white pixels Wp configured for displaying a white color. Alternatively or additionally, the pixels PX may include yellow pixels configured for displaying a yellow color, cyan pixels configured for displaying a cyan color, and magenta pixels configured for displaying a magenta color.

The pixels PX are arranged in a matrix configuration along the first direction D1 and the second direction D2. A pixel row may include pixels PX arranged in one row along the first direction D1. A pixel column may include pixels PX arranged in one column along the second direction D2. The display panel 400 includes a plurality of pixel rows and a plurality of pixel columns. FIG. 7 illustrates pixel columns C1 to C12 among the pixel columns and illustrates pixel rows R1 to R4 among the pixel rows.

In each odd-numbered pixel row of the pixel rows, red pixels Rp, green pixels Gp, blue pixels Bp, and white pixels Wp are arranged from the first pixel column C1 according to the repeated pattern of a red pixel Rp, a green pixel Gp immediately neighboring the red pixel Rp, a blue pixel Bp immediately neighboring the green pixel Gp, and a white pixel Wp immediately neighboring the blue pixel Bp. In each even-numbered pixel row of the pixel rows, red pixels Rp, green pixel Gp, blue pixels Bp, and white pixels Wp are arranged from the first pixel column C1 according to the repeated pattern of a blue pixel Bp, a white pixel Wp immediately neighboring the blue pixel Bp, a red pixel Rp immediately neighboring the white pixel Wp, and a green pixel Gp immediately neighboring the red pixel Rp.

The pixels PX include first-type blocks BL1 (or first blocks BL1, for conciseness) and second-type blocks BL2 (or second blocks BL2, for conciseness). FIG. 1 illustrates a first block BL1 and a second block BL2. The blocks BL1 and BL2 may be alternately arranged in the first direction D1. FIG. 7 illustrates two first blocks BL1 and two second blocks BL2 as examples. The display panel 400 may include other blocks BL1 and BL2.

The first blocks BL1 shown in FIG. 7 include a left first block LBL1 and a right first block RBL1, and the second blocks BL2 shown in FIG. 7 includes a left second block LBL2 and a right second block RBL2.

The blocks LBL1, LBL2, RBL1, and RBL2 shown in FIG. 7 include the pixel rows R1 to R4 as examples. The blocks LBL1, LBL2, RBL1, and RBL2 may include other pixel rows. The blocks LBL1, LBL2, RBL1, and RBL2 may include the pixels arranged in all pixel rows defined along the second direction D2 in the display panel 400.

In an embodiment, each of the blocks LBL1, LBL2, RBL1, and RBL2 may include three pixel columns. More particularly, the left first block LBL1 includes the first to third pixel columns C1 to C3, and the right first block RBL1 includes the seventh to ninth pixel columns C7 to C9. The left second block LBL2 includes the fourth to sixth pixel columns C4 to C6, and the right second block RBL2 includes the tenth to twelfth pixel columns C10 to C12.

A sum of the number of the white pixels Wp and the number of the green pixels Gp, that are included in the first blocks BL1 (e.g., 8 for LBL1 and RBL1 illustrated in FIG. 7) is unequal to (e.g., less than) a sum of the number of the white pixels Wp and the number of the green pixels Gp that are included in the second blocks BL2 (e.g., 16 for LBL2 and RBL2 illustrated in FIG. 7). The number of the pixels PX included in the first blocks BL1 is equal to the number of the pixels PX included in the second blocks BL2. A sum of the number of the red pixels Rp and the number of the blue pixels Bp that are included in the first block BL1 (e.g., 16 for LBL1 and RBL1 illustrated in FIG. 7) is unequal to (e.g., greater than) a sum of the number of the red pixels Rp and the number of the blue pixels Bp that are included in the second block BL2 (e.g., 8 for LBL2 and RBL2 illustrated in FIG. 7).

In an embodiment, the number of the white pixel(s) Wp and the number of the green pixel(s) Gp that are included in a first blocks BL1 and a second blocks BL2 satisfy the following relation of “q+p<r+s”. Here, “q” denotes the number of the white pixel(s) Wp included in the first block BL1 in a row, “p” denotes the number of the green pixel(s) Gp included in the first block BL1 in the row, “r” denotes the number of the white pixel(s) Wp included in the second block BL2 in the row, and “s” denotes the number of the green pixel(s) Gp included in the second block BL2 in the row.

For instance, since the red pixel Rp, the green pixel Gp, and the blue pixel Bp are arranged in the first pixel row R1 of the left first block LBL1, “q+p” in the left first block LBL1 is 1. Similarly, since the blue pixel Bp, the white pixel Wp, and the red pixel Rp are arranged in the first pixel row R1 of the right first block RBL1, “q+p” in the right first block RBL1 is 1.

The white pixel Wp, the red pixel Rp, and the green pixel Gp are arranged in the first pixel row R1 of the left second block LBL2, and thus “r+s” in the left second block LBL2 is 2. Similarly, since the green pixel Gp, the blue pixel Bp, and the white pixel Wp are arranged in the first pixel row R1 in the right second block RBL2, “r+s” in the right second block RBL2 is 2.

Analogous to the first pixel row R1, the pixels of each of the pixel rows R2, R3, and R4 may satisfy the relation of “q+p<r+s”.

In an embodiment, brightness coefficients of the red, green, blue, and white colors are different from each other. In an embodiment, the brightness coefficient associated with a white pixel may be greater than the brightness coefficient associated with a green pixel, which may be greater than the brightness coefficient associated with a red pixel, which may be greater than the brightness coefficient associated with a blue pixel. Even if pixels Rp, Gp, Bp, and Wp receive data voltages corresponding to the same grayscale level, the brightness of red, green, blue, white image portions respectively displayed in the pixels Rp, Gp, Bp, and Wp may be different.

As described above, the blocks BL1 and BL2 may include pixels PX that satisfy the relation of “q+p<r+s”. That is, more of white pixels Wp and green pixels Gp, which have relatively greater brightness coefficients, are included in the second blocks BL2 than in the first blocks BL1. If the blocks BL1 and BL2 receive data voltages of the same level, the brightness of the image displayed in the second blocks BL2 might be greater than the brightness of the image displayed in the first blocks BL1, such that conspicuous vertical line defects, in which darker lines and bright lines alternately appear, might be displayed by the display panel 400.

According to embodiments of the present invention, the pixels PX of the first blocks BL1 are applied with first data voltages generated based on the first gamma curve, and the pixels PX of the second blocks BL2 are applied with second data voltages generated based on the second gamma curve. The brightness value of the first gamma curve is greater than that of the second gamma curve with respect to the same grayscale level, and thus substantial difference in brightness between the first blocks BL1 and the second blocks BL2 may be prevented. Advantageously, conspicuous vertical line defects may be prevented, and satisfactory image display quality may be attained.

Although embodiments of the present invention have been described, the present invention should not be limited to these embodiments. Various changes and modifications can be made by one ordinary skilled in the art within the spirit and scope of the present invention.

What is claimed is:

1. A display device comprising:
a display panel comprising a first pixel group and a second pixel group, wherein the first pixel group comprises a first first-color pixel set and a first second-color pixel set, wherein the second pixel group comprises a second first-color pixel set and a second second-color pixel set, wherein the first first-color pixel set and the second first-color pixel set are configured to display a first color, wherein the first second-color pixel set and the second second-color pixel set are configured to display a second color, wherein a sum of a number of pixels of the first first-color pixel set and a number of pixels of the first second-color pixel set is unequal to a sum of a number of pixels of the second first-color pixel set and a number of pixels of the second second-color pixel set; and
a data driver configured to provide a first data voltage to the first pixel group and configured to provide a second data voltage to the second pixel group, wherein the data driver is configured to generate the first data voltage based on a first gamma curve, wherein the data driver is configured to generate the second data voltage based on a second gamma curve, and wherein a brightness value associated with the first gamma curve respect to a grayscale level is unequal to a brightness value associated with the second gamma curve with respect to the grayscale level.

2. The display device of claim 1, wherein the first pixel group further comprises a first third-color pixel set, wherein the first third-color pixel set is configured to display a third color, wherein a brightness coefficient of the third color is less than a brightness coefficient of the first color, wherein the sum of the number of pixels of the first first-color pixel set and the number of pixels of the first second-color pixel set is less than the sum of the number of pixels of the second first-color pixel set and the number of pixels of the second second-color pixel set, and wherein the brightness value associated with the first gamma curve with respect to the grayscale level is greater than the brightness value associated with the second gamma curve with respect to the grayscale level.

3. The display device of claim 2, wherein one of the first color and the second color is white.

4. The display device of claim 3, wherein another one of the first color and the second color is green.

5. The display device of claim 1, wherein a number of pixels of the first pixel group is equal to a number of pixels of the second pixel group.

6. The display device of claim 1, wherein each of the first pixel group and the second pixel group has exactly three pixel columns.

7. The display device of claim 1, wherein a first-color pixel of the first pixel group is positioned between a first third-color pixel of the first pixel group and a first fourth-color pixel of the first pixel group in a first direction, wherein a second-color pixel of the first pixel group is positioned between a second fourth-color pixel of the first pixel group and a second third-color pixel of the first pixel group in the first direction, wherein the first third-color pixel of the first pixel group and the second third-color pixel of the first pixel group are configured to display a third color, wherein the first fourth-color pixel of the first pixel group and the second fourth-color pixel of the first pixel group are configured to display a fourth color, and wherein the first-color pixel of the first pixel group immediately neighbors the second-color pixel of the first pixel group in a second direction perpendicular to the first direction.

8. The display device of claim 7, wherein the first third-color pixel of the first pixel group immediately neighbors the second fourth-color pixel of the first pixel group in the second direction, and wherein the first fourth-color pixel of the first pixel group immediately neighbors the second third-color pixel of the first pixel group in the second direction.

9. The display device of claim 7, wherein the first-color pixel of the first pixel group immediately neighbors each of the first third-color pixel of the first pixel group and the first fourth-color pixel of the first pixel group, and wherein the second-color pixel of the first pixel group immediately neighbors each of the second fourth-color pixel of the first pixel group and the second third-color pixel of the first pixel group.

10. The display device of claim 7, wherein one of the third color and the fourth color is red, and wherein another one of the third color and the fourth color is blue.

11. The display device of claim 1, wherein a third-color pixel of the second pixel group is positioned between a first first-color pixel of the second pixel group and a first second-color pixel of the second pixel group in a first direction, wherein a fourth-color pixel of the second pixel group is positioned between a second second-color pixel of the second pixel group and a second first-color pixel of the second pixel group in the first direction, wherein the third-color pixel of the second pixel group is configured to display a third color, wherein the fourth-color pixel of the second pixel group is configured to display a fourth color, and wherein the third-color pixel of the second pixel group immediately neighbors the fourth-color pixel of the second pixel group in a second direction perpendicular to the first direction.

12. The display device of claim 11, wherein the first first-color pixel of the second pixel group immediately neighbors the second second-color pixel of the second pixel group in the second direction, and wherein the first second-color pixel of the second pixel group immediately neighbors the second first-color pixel of the second pixel group in the second direction.

13. The display device of claim 11, wherein the third-color pixel of the second pixel group immediately neighbors each of the first first-color pixel of the second pixel group and the first second-color pixel of the second pixel group, and wherein the fourth-color pixel of the second pixel group immediately neighbors each of the second second-color pixel of the second pixel group and the second first-color pixel of the second pixel group.

14. The display device of claim 1, wherein the display panel further comprises a third pixel group, wherein the second pixel group is positioned between the first pixel group and the third pixel group, wherein the third pixel group comprises a third first-color pixel set and a third second-color pixel set, wherein the third first-color pixel set is configured to display the first color, wherein the third second-color pixel set is configured to display the second color, wherein a sum of a number of pixels of the third first-color pixel set and a number of pixels of the third second-color pixel set is unequal to the sum of the number of pixels of the second first-color pixel set and the number of pixels of the second second-color pixel set, wherein the data driver is configured to provide a third data voltage to the third pixel group, and wherein the data driver is configured to generate the third data voltage based on the first gamma curve.

15. The display device of claim 14, wherein the sum of the number of pixels of the third first-color pixel set and the number of pixels of the third second-color pixel set is equal to the sum of the number of pixels of the first first-color pixel set and the number of pixels of the first second-color pixel set.

16. The display device of claim 14, wherein the display panel further comprises a fourth pixel group, wherein the third pixel group is positioned between the second pixel group and the fourth pixel group, wherein the fourth pixel group comprises a fourth first-color pixel set and a fourth second-color pixel set, wherein the fourth first-color pixel set is configured to display the first color, wherein the fourth second-color pixel set is configured to display the second color, wherein a sum of a number of pixels of the fourth first-color pixel set and a number of pixels of the fourth second-color pixel set is unequal to the sum of the number of pixels of the third first-color pixel set and the number of pixels of the third second-color pixel set, wherein the data driver is configured to provide a fourth data voltage to the fourth pixel group, and wherein the data driver is configured to generate the fourth data voltage based on the second gamma curve.

17. The display device of claim 16, wherein the sum of the number of pixels of the fourth first-color pixel set and the number of pixels of the fourth second-color pixel set is equal to the sum of the number of pixels of the second first-color pixel set and the number of pixels of the second second-color pixel set.

18. The display device of claim 1, wherein the data driver comprises a first voltage generator configured to generate the first data voltage and comprises a second voltage generator configured to generate the second data voltage,
wherein the first voltage generator comprises:
a first gamma voltage generator for generating a first gamma voltage according to the first gamma curve in response to a first gamma voltage control signal; and
a first digital-to-analog converter for converting a first image data set to the first data voltage based on the first gamma voltage, and
wherein the second voltage generator comprises:
a second gamma voltage generator for generating a second gamma voltage according to the second gamma curve in response to a second gamma voltage control signal; and
a second digital-to-analog converter for converting a second image data set to the second data voltage based on the second gamma voltage.

19. The display device of claim 18, further comprising:
an image mapping part for generating an intermediate data having information about the first color, the second color, a third color, and fourth color based an input image signal having information about the second color, the third color, and the fourth color;
a data separating part for separating the intermediate data into the first image data set and the second image data set; and
a gamma controlling part for generating the first gamma voltage control signal and the second gamma voltage control signal.

20. The display device of claim 19, further comprising:
a first electrically conductive line electrically connected to each of the data separating part and the first voltage generator and configured to transmit the first image data set from the data separating part to the first voltage generator; and
a second electrically conductive line electrically connected to each of the data separating part and the second voltage generator and configured to transmit the second image data set from the data separating part to the second voltage generator.
